(19) United States
(12) Patent Application Publication
(10) Pub. No.: US 2005/0259679 A1
(43) Pub. Date: Nov. 24, 2005

(54) Radio link loss management in multimedia domain (MMD)

(76) Inventors: Kuntal Chowdhury, Plano, TX (US); Jayshree Bharatia, Plano, TX (US); Marvin Bienn, Dallas, TX (US)

Correspondence Address: DOCKET CLERK, P.O. DRAWER 800889, DALLAS, TX, 75380, US

(21) Appl. No.: 11/105,629

(22) Filed: Apr. 14, 2005

Related U.S. Application Data
(60) Provisional application No. 60/562,616, filed on Apr. 15, 2004.

(51) Int. Cl. H04L 12/66

(52) U.S. Cl. 370/465; 370/310

(57) ABSTRACT

In accordance with the teachings of the present invention, a method and apparatus is presented to manage resources after the loss of radio link in an MMD network. The present invention provides a system and method for how a 3rd Generation Partnership Project 2 (3GPP2) Packet-Data Subsystem signals to a 3GPP2 IP Multimedia System that a terminal device has lost radio contact and how the 3GPP2 IP Multimedia System revokes all authorizations and releases all resources associated with the terminal device.

### FIELD OF THE INVENTION

The present invention relates to how a packet-data subsystem informs a supporting IP Multimedia System that a terminal device has lost radio contact.

### BACKGROUND

The 3GPP2 Multimedia Domain (MMD) is a Code Division Multiple Access (CDMA) based wireless network providing 3rd generation capabilities and based on IP protocols, elements and principles. The MMD architecture is comprised of three subsystems, a Packet-Data Subsystem (PDS), a IP Multimedia Subsystem (IMS) and a Multimedia Application Server (MAS) domain. The Packet-Data Subsystem provides IP connectivity between the CDMA terminal device and the IP network (e.g., private or public internet). The PDS is responsible for authenticating and authorizing the terminal device at a network subscriber level. The PDS maintains IP connectivity with the terminal device even though the terminal device might be highly mobile (e.g., traveling within an automobile). The IMS provides provisioning for IP multimedia services. The IMS is responsible for authenticating and authorizing multimedia services. IP multimedia services are based on an Internet Engineering Task Force (IETF) defined session control protocols. Some of the session control protocols include Session Initiation Protocol (SIP) and Session Description Protocol (SDP). The IP Multimedia subsystem utilizes the PDS to transport multimedia signaling and bearer traffic. The mobility of the terminal device is hidden, transparent, to IMS through the PDS. The MAS domain is a collection of entities that provide specific service capabilities for the MMD (e.g., geo-location capabilities, presence capabilities). The services provided by the MAS domain services are developed by the mobile network operator and any other third party suppliers including those in the Internet space using the mechanisms provided by the Internet and the IMS.

The goal of developing IMS was to allow for access independence and to maintain a smooth interoperation with wireline or wireless terminals across the Internet. IMS was developed to stop the development of differentiated networks that are based on services or functionality (e.g., voice-only network, video-only network). IMS created a generalized framework that should enable the convergence of, and access to, voice, video, messaging, data and web-based technologies for the wireless user, and combine the growth of the Internet with the growth in mobile communications.

The IMS controls all session control signaling for multimedia sessions. This implies that the initiation, modification and termination of a multimedia session is controlled by the IMS through interactions with a terminal device. On the other hand, the PDS provides support for the transport (IP bearers) for all data traffic associated with the multimedia session through interactions with a terminal device. The only time the PDS communicates with the IMS is when the PDS is triggered by a request from the terminal device (e.g., for the establishment of IP bearers) or the IMS terminates the multimedia session and then request the PDS to terminate the associated IP bearers (e.g., the subscriber's prepaid account is empty). A problem occurs if a terminal device establishes a multimedia session and has successfully been granted IP bearers and then losses contact with the PDS. Even thought the PDS could de-allocate the IP bearers associated with the terminal device, there is no mechanism that allows the PDS to inform the IMS of the situation, which would then allow the IMS to terminate any established multimedia services. Without the IMS terminating the multimedia session there is the chance that the user will be falsely billed if the multimedia service charging model is based upon length of established time.

### SUMMARY

This invention provides a system and method for how a 3GPP2 Packet-data Subsystem signals a 3GPP2 IP Multimedia Subsystem that a terminal device has lost radio contact. In one embodiment, a Policy Decision Function (PDF) is used to communicate information to the Proxy Call Session Control Function (P-CSCF) that a particular a terminal device has a lost radio contact allowing the P-CSCF to then terminate any established multimedia sessions on behalf of the terminal device.

A method of resource management for a terminal device when a radio link between the terminal link and a network has been lost, comprises the steps of receiving an indication of the loss of a radio link between the terminal device and the network and that resources associated therewith should be torn down; sending session information at PDSN to a supporting PDF identifying each of the sessions that have been disconnected due to radio link loss with the terminal device; sending the session information received at the PDF to a P-CSCF identifying each of the sessions that have been disconnected due to radio link loss with the terminal device; and tearing down resources at the PDSN, PDF and P-CSCF for established sessions associated with the terminal device when the radio link contact with the network is lost.

A method of operating a network, comprises the steps of receiving a first termination request identifying media flows associated with a session from a PDSN; removing authorization for the media flows associated with the session in response to receiving the first termination request; and transmitting a second termination request identifying the media flows associated with the session to a P-CSCF in response to removing authorization for the media flows associated with the session.

A method of resource management, comprises the steps of receiving an indication of loss of a radio link between a terminal device and a network; and operating a PDF between a PDSN and a P-CSCF to manage resources after loss of radio link contact between a terminal device and a network, for established sessions created by the terminal device before radio contact with the network was lost.

### BRIEF DESCRIPTION OF THE DRAWINGS

FIG. 1 is a simplified diagram of a 3GPP2 Multimedia Domain network for supporting multimedia services.

FIG. 2 is a diagram of embodiments of a signal and message exchange sequence for informing the 3GPP2 IP Multimedia System that a radio loss condition has occurred.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

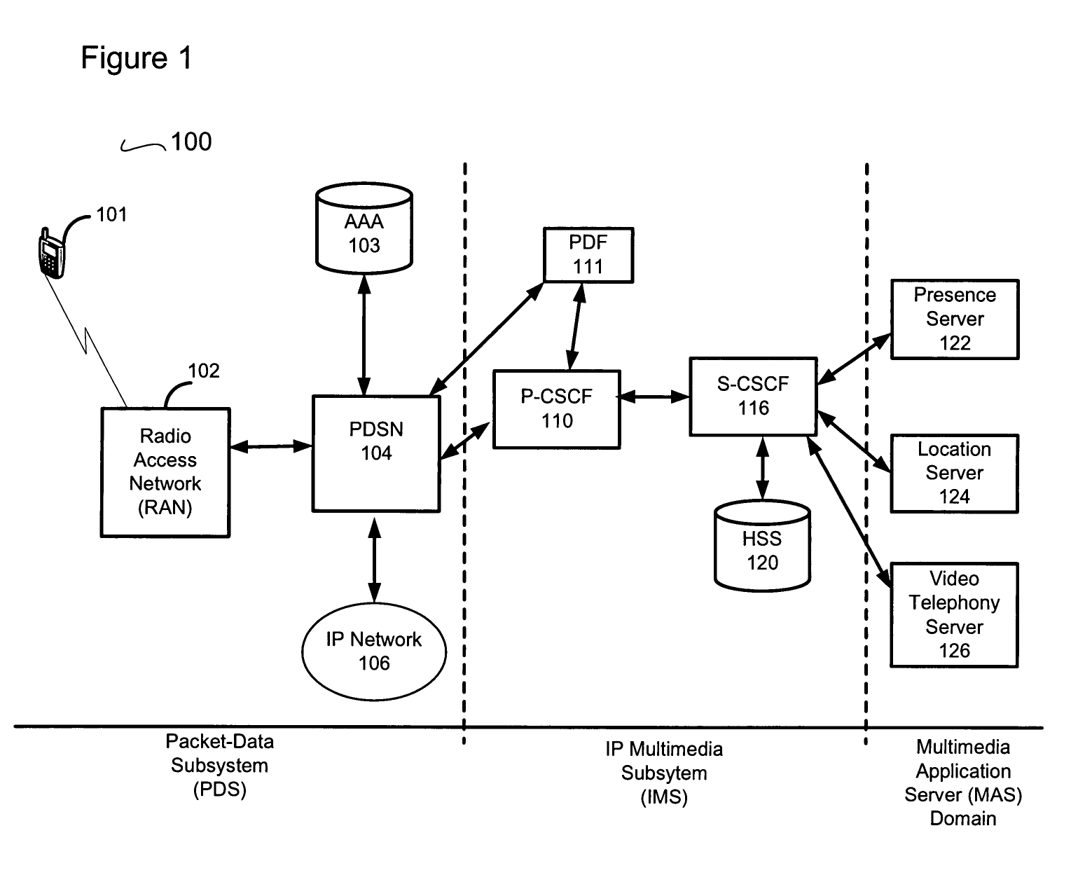

FIG. 1 is a simplified diagram of an embodiment of a telecommunications system which supports Multimedia Domain (MMD) operations according to the 3rd Generation Partnership Project 2 (3GPP2) standards. In the following discussion, numerous specific details are set forth to provide a thorough understanding of the present invention. However, it will be apparent to those skilled in the art that the present invention can be practiced without such specific details. In other instances, well-known elements have been illustrated in schematic or block diagram form in order not to obscure the present invention in unnecessary detail. It is further noted that functions described herein may be performed by a processor such as a computer or electronic data processor in accordance with code such as computer program code, software, and/or integrated circuits that are coded to perform such functions.

Telecommunications system 100 is a simplified block diagram of a Multimedia Domain. In the illustrative examples provided herein, telecommunication system 100 provides multimedia service to terminal device (101). In order for terminal device 101 to initiate any multimedia service, it must first contact the Radio Access Network (RAN) 102. The connection between terminal device 101 and RAN 102 is called a radio link. For MMD, RAN 102 supports Code Division Multiple Access (CDMA) wireless protocols. RAN 102 may perform mobility management functions for registering, authorizing, authenticating and paging device terminal device 101. RAN 102 may perform handoffs between other RANs.

The Packet Data Serving Node (PDSN) 104 is an IP gateway. The PDSN 104 provides the connectivity with RAN 102 allowing for the transport of bearer streams which includes upper layer signaling for the establishment of multimedia signals (e.g., SIP) and for user traffic (e.g., video). PSDN 104 contains a Policy Enforcement Function (PEF) that has the capability of policing packet flow between RAN 102 and IP destinations within IP Network (IPN), 106, and restricting the set of IP destinations for which terminal device 101 can communicate within IPN 106.

The PDSN 104 provides access to network level registration and authentication for terminal device 101. In order to authenticate a terminal device 101, PDSN 104 communicates with Authentication, Authorization and Accounting (AAA) 103. AAA 103 provides IP based Authentication, Authorization, and Accounting functions. Authentication is the process of verifying that terminal device 101 is allowed to use the IP network functionality of Telecommunication system 100. Authorization is the process of determining whether terminal device 101 is allowed to use the IP network functionality of telecommunications system 100 (e.g., request for a bidirectional IP channel using 100 Kbits/seconds). Accounting is the process of gathering information about the IP network functionality that was authorized (e.g., terminal device 101 sent 10 Mbits over a 100 kbit/second bi-directional IP channel during a 30 minute time period).

If terminal device 101 is attempting to initiate a multimedia service, the IP packet containing the Multimedia Service Request is transported through RAN 102, through PDSN 104 to the Proxy Call Session Control Function (P-CSCF) 110. The P-CSCF 110 is the first contact point within the IMS for terminal device 101. The P-CSCF 110 behaves like a Proxy (as defined in RFC 3261 or subsequent versions), i.e. it accepts SIP requests and services them internally or forwards them on. In some situations the P-CSCF can act as a Back-to-Back User Agent (B2BUA). A B2BUA is a Session Initiation Protocol (SIP) based logical entity that can receive and process SIP messages as a SIP User Agent Server (UAS). It also acts as a SIP User Agent Client (UAC) that determines how a SIP request should be answered and how to initiate outbound calls. Unlike a SIP proxy server, the B2BUA maintains complete call state information and participates in all call requests. P-CSCF 110 forwards all SIP messages received from terminal device 101 to the SIP server whose name the P-CSCF has received as a result of the IMS registration procedure.

Both P-CSCF 110 and PDSN 104 may communicate with Policy Decision Function (PDF) 111. PDF 111 provides management of bearer resources within the PDS necessary to support multimedia services to terminal device 101. PDF 101 provides IP destination addresses and ports for whom terminal device 101 is authorized to communicate with to PDSN 104. The IP destination addresses and ports for whom terminal device 101 is authorized to communicate with is provided by P-CSCF 110 as part of a multimedia service establishment procedure.

Serving-CSCF (S-CSCF) 116 performs the session control services for terminal device 101. S-CSCF 116 is the SIP server that terminal device 101 contacts for establishing IMS registration. Like P-CSCF 11, S-CSCF 116 can also act as a Back-to-Back User Agent (B2BUA). S-CSCF 116 may have connectivity with various types of application servers providing Multimedia Services for terminal device 101. Examples might include a Presence Server 122, a Location Server 124 or even a Video Telephony Server (VTS) 126. For authenticating terminal device 101, S-CSCF 116 communicates with Home Subscriber Server (HSS) 120. HSS 120 contains the subscription-related information to support the network entities handling multimedia calls/sessions. HSS 120 is responsible for holding the following user related information: User Identification, Numbering and addressing information, User Security information, and User profile information.

In general, for establishing a multimedia session for a particular multimedia service, say video telephony, terminal device 101 would send a multimedia service request (e.g., SIP INVITE) containing information as to what multimedia service terminal device 101 desires to initiate and information as to the media stream requirements for supporting the service (e.g., for video telephony terminal device would require an audio media stream with the voice data formatted in a certain manner, and a video media steam requiring a minimal amount of bandwidth, 50 Kbits per second). The multimedia service request would be routed through RAN 102, PDSN 104, P-CSCF 110 and then authorized by S-CSCF 116. S-CSCF 116 would then route the request to the appropriate application server based upon the type of multimedia service requested, for example VTS 126. VTS 126 would analyze the offer sent in the SIP INVITE and respond with an answer to the offer (e.g., with a SIP 183 Session Progress message). The response would be routed back though S-CSCF 116 to P-CSCF 110 where P-CSCF would store information within the answer (e.g., agreed upon media stream information). P-CSCF 110 would then send the response back to terminal device 101 though PDSN 104 and RAN 102.

After receiving the response, terminal device 101 constructs a bearer request and sends it to PDSN 104 requesting PDSN 104 to guarantee IP bearer resources that fulfill the media stream requirements agreed to. PDSN 104 would communicate with PDF 111 to determine from the IMS part of the network as to what the IMS network authorized. PDF 111 would then contact P-CSCF 110 to retrieve the stored information about the multimedia session for which terminal device 101 is attempting to request IP bearer resources. PDF 111 would then decide whether to grant or reject the bearer request and forward the decision to PDSN 104. Assuming that PDF 111 did grant the bearer request, PDSN 104 would reserve IP bearer resources in the PDS and send the bearer request response back to terminal device 101. Terminal device 101 would then signal (through P-CSCF 110 and S-CSCF 116) to VTS 126 that the IP bearer resources to support the media streams are in place. VTS 126 would send a final response to the SIP INVITE that would trigger the start of video telephony data to be sent across the IP bearer resources.

The signaling part of the MMD network is represented by the IMS. The network elements of the IMS (i.e., P-CSCF 110, S-CSCF 116) control the signaling aspects of multimedia session initiation, establishment, modification and termination. These signaling aspects are exchanged between the IMS network elements and terminal device 101 with the PDS network elements (e.g., RAN 102 and PDSN 104) performing only routing functionality. The bearer path of the MMD network, represented by the PDS network elements, will only initiate communicate with IMS network elements (e.g., PDF 111) when triggered by terminal device 101 (e.g., when making a bearer request to PDSN 104). A problem occurs if for some reason a multimedia session was successfully established and IP bearers granted and then terminal device 101 losses radio contact with RAN 102 (e.g., terminal device losses power, terminal devices moves out of radio coverage). Even though PDSN 104 could de-allocate the IP bearers associated with terminal device 101, there is no mechanism that allows PDSN 104 to forward information to P-CSCF 110 for the purpose of informing P-CSCF 110 that all multimedia session associated with terminal device 101 should be terminated. Without the IMS network elements terminating the multimedia sessions there is the chance that the user associated with terminal device 101 need be falsely billed due to loss of radio link contact with the network.

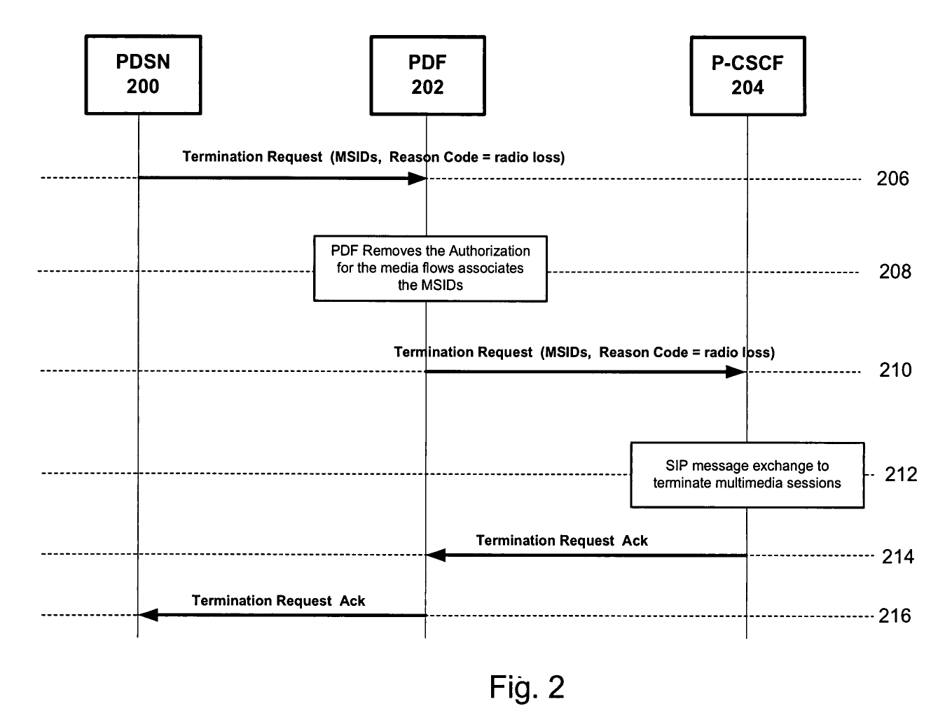

FIG. 2 is a diagram of embodiments of a signal and message exchange sequence for informing the 3GPP2 IP Multimedia System that a radio loss condition has occurred. It is assumed that at least one multimedia session has been successfully established and IP bearers associated with the multimedia sessions were authorized. Particularly, embodiments described herein provide a mechanism for informing the 3GPP2 IMS network element P-CSCF of a radio loss condition, allowing the P-CSCF to terminate the multimedia sessions associated with the terminal device that lost radio contact. PDSN 200 receives an indication of the loss of a radio link between the terminal device the RAN, for which it was previously transporting bearer data associated with multimedia sessions through. PDSN 200, based upon local policy, decides to send a Termination Request (step 206) to the PDF 202. Termination Request (step 206) contains identifiers for the multimedia sessions (MSIDs) to be terminated and a reason code for the termination (e.g., loss of radio contact between the RAN and the terminal device). As shown in step 208, the PDF 202 using the received MSIDs removes authorizations for the media streams associated with the MSIDs. The PDF 202 sends a Termination Request (step 210) to the P-CSCF 204. Termination Request (step 210) contains identifiers for the multimedia sessions (MSIDs) to be terminated and a reason code for the termination (e.g., loss of radio contact between the RAN and the terminal device). As shown in step 212, the P-CSCF 204 acting as a B2BUA contacts the terminal devices associated with MSIDs to terminate the established multimedia sessions. The P-CSCF 204 sends a Termination Request Acknowledgement (step 214) to the PDF 202. The PDF 202 releases all resources associated with the MSIDs (e.g., any stored information associated with the media steams supporting the multimedia sessions identified by the MSIDs). The PDF 202 sends a Termination Request Acknowledgement (step 216) to the PDSN 200. The PDSN 200 releases all resources associated with the MSIDs (e.g., stored IP addresses and port numbers associated with the MSIDs).

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

It is, therefore, intended by the appended claims to cover any and all such applications, modifications, and embodiments within the scope of the present invention.

1. A method of resource management for a terminal device when a radio link between the terminal device and a network has been lost, comprising the steps of:
receiving an indication of the loss of a radio link between the terminal device and the network and that resources associated therewith should be torn down;
sending session information at PDSN to a supporting PDF identifying each of the sessions that have been disconnected due to radio link loss with the terminal device;
sending the session information received at the PDF to a supporting P-CSCF identifying each of the sessions that have been disconnected due to radio link loss with the terminal device; and
tearing down resources at the PDSN, PDF and P-CSCF for established sessions associated with the terminal device when the radio link contact with the network is lost.

2. A method of operating a network, comprising the steps of:
receiving a first termination request identifying media flows associated with a session from a PDSN;
removing authorization for the media flows associated with the session in response to receiving the first termination request; and
transmitting a second termination request identifying the media flows associated with the session to a P-CSCF in response to removing authorization for the media flows associated with the session.

3. A method of operating a network as set forth in claim 2, the first termination request further comprising indicators that identify multimedia sessions associated with the media flows.

4. A method of operating a network as set forth in claim 2, the first termination request further comprising a reason for the first termination request.

5. A method of operating a network as set forth in claim 4, wherein the reason for the first termination request is a loss of a radio link contact between a terminal device and the network.

6. A method of operating a network as set forth in claim 2, further comprising the step of terminating multimedia sessions on behalf of the terminal device at a P-CSCF in response to the second termination request.

7. A method of operating a network as set forth in claim 6, wherein the step of terminating the multimedia sessions associated with the terminal device is accomplished by performing a SIP message exchange.

8. A method of resource management, comprising the steps of:
receiving an indication of loss of a radio link between a terminal device and a network; and
operating a PDF between a PDSN and a P-CSCF to manage resources after loss of radio link contact between a terminal device and a network, for established sessions created by the terminal device before radio contact with the network was lost.

9. A method of resource management as set forth in claim 8, wherein the step of managing the resources further comprising the step of communicating termination requests between the PDSN and the P-CSCF to remove the established sessions.

10. A method of resource management as set forth in claim 8, wherein the step of managing resources after the loss of the radio link further comprises the step of removing authorization for media flows associated with the established sessions.

11. A method of resource management as set forth in claim 10, wherein the step of removing authorization for media flows associated with the established sessions is performed in a PDF.

12. A method of resource management as set forth in claim 8, wherein the step of managing resources after the loss of the radio link further comprises the step of transmitting a termination request, the termination request causing a P-CSCF to perform a SIP message exchange for the purpose of terminating the established sessions.
